(19) United States
(12) Patent Application Publication
(10) Pub. No.: US 2007/0011001 A1
(43) Pub. Date: Jan. 11, 2007

(54) Apparatus for predicting the spectral information of voice signals and a method therefor

(75) Inventor: Hyun-Soo Kim, Yongin-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/483,890

(22) Filed: Jul. 10, 2006

(30) Foreign Application Priority Data
Jul. 11, 2005 (KR) 2005-62258

(51) Int. Cl. G10L 19/00

(52) U.S. Cl. 704/219

(57) ABSTRACT

Disclosed is a method for predicting the spectral information of voice signals, including inputting the voice signals, performing morphological operations with the waveform image of the voice signals, extracting harmonic peaks as a result of the morphological operations, and predicting the spectral envelope information of the voice signals by interpolating the harmonic peaks.

This application claims priority under 35 U.S.C. § 119 to an application entitled “Apparatus for Predicting the Spectral Information of Voice Signals and a Method Therefor” filed in the Korean Intellectual Property Office on Jul. 11, 2005 and assigned Ser. No. 2005-0062258, the contents of which are incorporated herein by reference.

### BACKGROUND OF THE INVENTION

1. Field of the Invention The present invention relates a voice signal processing system, and more particularly to an apparatus and method for predicting the spectral information of voice or sound signals in a voice signal processing system.

2. Description of the Related Art The spectral information of voice signals has generally been used for the voice signal processing system to encode, compress, transmit, recognize and synthesize the voice signals in the frequency domain. The spectral information affects the sound quality of the voice signals having been processed.

Meanwhile, a large amount of data and time is required to encode and transmit the whole spectrum of voice signals to the voice signal processing system. In order to eliminate such problems, there has been a recently proposal to enable the voice signal processing system to decode the spectrum envelope information consisting of the harmonic elements instead of the whole spectrum of voice signals. To this end, various methods have been proposed for predicting the spectrum envelope information of voice signals, one of which is the widely used linear prediction analysis method.

The linear prediction analysis assumes the present sample as a linear combination of the past samples, so that they are multiplied by a linear prediction coefficient, and then combined to predict the value of the present sample. This analysis decreases the amount of computation because the characteristics of the voice signals are represented by parameters easily extracted by a simple calculation. Therefore, a small number of the parameters suffice to represent the waveform and spectrum of the voice signals in analyzing, synthesizing and compressing the voice signals.

However, the reliability of the linear prediction analysis depends on the linear prediction order, and therefore may be improved by increasing the linear prediction order, thus resulting in an increase in the amount of computation. This analysis also applies to the signals assumed stable for a short duration, so that it becomes difficult to predict the present sample by employing the past unstable samples. For example, in the transition region of the voice signals where they undergo abrupt changes, the prediction of the present sample by using the past samples is failed.

Further, the linear prediction analysis can hardly detect the spectral envelope unless the balance between the time axis and the frequency axis resolution is maintained when applying data windowing. For example, when the pitch of the voice signals is high, the distance between the harmonics becomes large so that the linear prediction analysis results in individual harmonics instead of the spectral envelope. Hence, its reliability is decreased when there is a high pitch as with female and child voices, for example. Namely, the linear prediction analysis applies provided that the vocal tract transfer function is modeled by the linear all-pole model, and therefore its reliability tends to be decreased for the voice signals to which the linear all-pole model does not apply.

### SUMMARY OF THE INVENTION

It is an object of the present invention to provide an apparatus and method for predicting the spectral information of voice signals by analyzing their own morphology without making presumptions for them.

It is another object of the present invention to provide an apparatus and method for predicting the spectral information of voice signals by using their harmonic peaks and additional important information.

According to the present invention, an apparatus for predicting the spectral information of voice signals includes a voice signal input device for inputting the voice signals, a morphological filter for performing morphological operations with the waveform image of the voice signals, a harmonic peak extractor for extracting harmonic peaks as a result of the morphological operations, and a spectral envelope prediction device for predicting the spectral envelope information of the voice signals by interpolation of the harmonic peaks.

According to the present invention, an apparatus for predicting the spectral information of the voice signals includes a voice signal input device for inputting voice signals, a morphological filter for performing morphological operations with the waveform image of the voice signals, a harmonic peak extractor for extracting harmonic peaks as a result of the morphological operations, a high order peak selector for selecting higher order peaks among the extracted harmonic peaks, and a spectral envelope prediction device for predicting the spectral envelope information of the voice signals by interpolation of the higher order peaks.

According to the present invention, a method for predicting the spectral information of voice signals includes inputting the voice signals, performing morphological operations with the waveform image of the voice signals, extracting harmonic peaks as a result of the morphological operations, and predicting the spectral envelope information of the voice signals by interpolation of the harmonic peaks.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram for illustrating an apparatus for predicting the spectral information of voice signals according to the present invention;

FIG. 2 is a flowchart for illustrating a method for predicting the spectral information of voice signals according to the present invention;

FIG. 3 is a first graph for showing the dilation result of the morphological operations according to the present invention;

FIG. 4 is a second graph for showing the dilation result of the morphological operations according to the present invention;

FIG. 5 is a graph for illustrating the interpolation of harmonic peaks obtained by heating peak extraction according to the present invention;

FIG. 6 is a graph for illustrating the interpolation of harmonic peaks obtained by midpoint extraction according to the present invention;

FIG. 7 is a graph for illustrating the interpolation of harmonic peaks obtained by tracking peak extraction according to the present invention;

FIGS. 8A, 8B and 8C are waveforms for illustrating the procedure of defining higher order peaks according to the present invention; and

FIG. 9 is a graph for illustrating the selection of second order peaks according to the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail for the sake of clarity and conciseness.

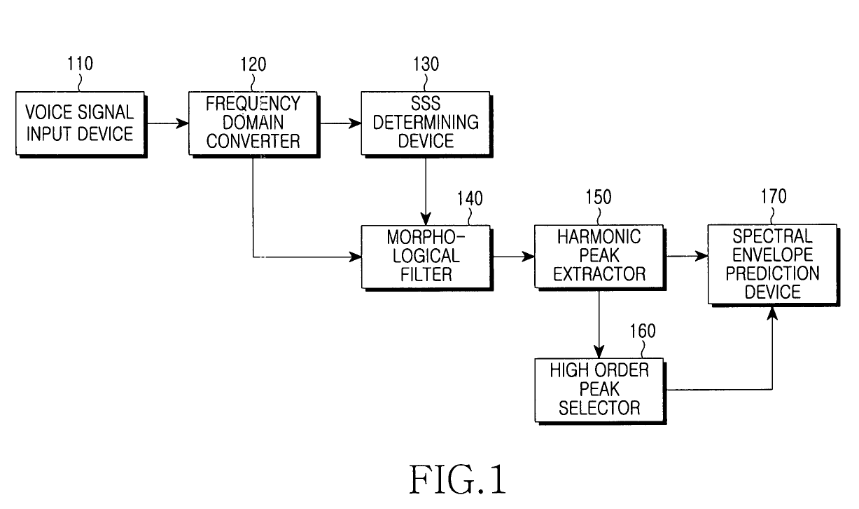

Referring to FIG. 1, the apparatus for predicting the spectral information of the voice signals includes a voice signal input device 110, a frequency domain converter 120, a structuring set size (SSS) determining device 130, a morphological filter 140, a harmonic peak extractor 150, a high order peak selector 160, a spectral envelope prediction device 170 and a voice signal processing system (not shown).

The voice signal input device 110 may consist of a microphone for receiving the voice signals. The frequency domain converter 120 is to convert the voice signals in the time domain into those in the frequency domain through a suitable procedure such as FFT (Fast Fourier Transform).

The morphological filter 140 performs morphological operations with the waveform of the voice signals in the frequency domain. The morphological operation is a non-linear image processing and analysis concentrating on the geometrical structure of the image. The morphological operations may be a plurality of linear and non-linear operators combining primary operations of dilation and erosion and secondary operations combining opening and closing.

According to the present invention, the morphological filter 140 performs the operations of dilation, erosion, opening and closing with the one-dimensional waveform of the voice signals in the frequency domain to partially transform the geometrical characteristics of the waveform image of the voice signals. The morphological operation is a set-theoretical approach depending on the fitting of the structuring elements to certain particular values, representing a one-dimensional image-structuring element such as the voice signals waveform by a set of discrete values. In this case, the structuring set is determined by the sliding window symmetrical to the origin, the size of which determines the reliability of the morphological operations. The size of the sliding window is expressed by the following Equation 1.
Size of Sliding Window=SSS*2+1 (1)

As shown by Equation 1, the size of the sliding window varies with SSS. Accordingly, the size of the structuring set (SSS) determines the reliability of the morphological operations. The SSS determining device 130 determines the SSS to optimize the performance of the morphological filter 140. The morphological filter 140 performs the operations of dilation or erosion and then opening or closing by employing the sliding window depending on the SSS determined by the SSS determining device 130.

The operation of dilation is to determine the maximum of each of selected threshold sets of the waveform image of the voice signals as the threshold set value. The operation of erosion is to determine the minimum of each threshold set of the waveform image of the voice signals as the threshold set value. The operation of opening is the operation of dilation performed after the operation of erosion, resulting in a smoothing effect. The operation of closing is the operation of erosion performed after the operation of dilation, resulting in a filling effect.

Thus, the morphological filter 140 performs the operations of dilation or erosion, and then opening or closing. When the operation of dilation determines the maximum of each threshold set of the waveform image of the voice signals as the threshold set value, the threshold set is termed a dilated region. Conversely, when the operation of erosion determines the minimum of each threshold set of the waveform image of the voice signals as the threshold set value, the threshold set is termed an erosion region.

As the result of the operations of dilation or erosion and then opening or closing, the morphological filter 140 generates the discrete signals waveform representing discretely dilation or erosion regions. The harmonic peak extractor 150 extracts the harmonic peaks of each region from the discrete signals waveform generated by the morphological filter 140. The harmonic peak extractor 150 extracts the harmonic peaks by using the following three procedures.

The first extraction procedure is heating peak extraction for extracting the meeting point of each harmonic peak and a dilation or erosion region as the peak value. The second extraction procedure is midpoint extraction for extracting the midpoint of each dilation or erosion region as the peak value. The third extraction procedure is tracking peak extraction for extracting the substantial spectral peak causing each dilation or erosion region to be dilated or eroded. These three extraction procedures considerably decrease the probability of extracting noises because the harmonic peaks occupy higher levels than the noises.

The high order peak selector 160 defines the order of each of the harmonic peaks extracted by the harmonic peak extractor 150 to select the higher order peaks with more information of the voice signals by using theorems of higher order peaks. The theorems of higher order peaks are as follows:

1. Only a single valley or peak exists between continuous peaks or valleys.

2. The first theorem applies to the peaks or valleys of each order.

3. The number of higher order peaks or valleys is less than that of lower order peaks or valleys, and the higher order peaks or valleys exist in the subset between the lower order peaks or valleys.

4. Between any two continuous higher order peaks or valleys exists at least one lower order peak or valley.

5. The higher order peaks or valleys have a higher mean level than the lower order peaks or valleys.

6. Through a particular duration (e.g., a single frame) exists an order having a single peak and valley (e.g., the maximum and the minimum value in a single frame).

According to the theorems of higher order peaks, the high order peak selector 160 first defines the harmonic peaks extracted by the harmonic peak extractor 150 as first order peaks, and then higher order peaks between the first order peaks as second order peaks. Namely, the higher peaks appearing in the sequential time series of the first order peaks are defined as the second order peaks. In this manner, the higher peaks appearing in the second order peaks are defined as the third order peaks. Likewise, the higher order valleys (or minima) may be defined, so that the second order valleys are the local valleys appearing in the sequential time series of the first order valleys.

Such higher order peaks or valleys may be used as very effective statistical values in extracting the characteristics of the voice or audio signals, particularly the second and the third order peaks having the pitch information of the voice or audio signals. In addition, the number of the time or sampling points between the second and third order peaks has a substantial amount of information for extracting the characteristics of the voice signals. Hence, the high order peak selector 160 preferably selects the second and third order peaks among the harmonic peaks extracted by the harmonic peak extractor 150.

The spectral envelope prediction device 170 extracts the spectral envelope of the voice signals based on the peaks extracted by the harmonic peak extractor 150 or on the particular order peaks selected by the high order peak selector 160. Or otherwise, without using the higher order peaks, the spectral envelope prediction device 170 extracts the spectral envelope of the voice signals by interpolation of the harmonic peaks extracted by the harmonic peak extractor 150. Alternatively, the spectral envelope prediction device 170 extracts the spectral envelope of the voice signals by interpolation of the particular order peaks extracted by the high order peak selector 160.

As described above, the apparatus for predicting the spectral information of the voice signals can predict the spectral envelope information by using the harmonic peaks of the voice signals without making presumptions for them, so that the spectral information is more accurate than with the conventional apparatus. Moreover, the present apparatus only requires the peak information of the voice signals to obtain the spectral envelope information, thereby expediting the extraction process with significantly reduced computation.

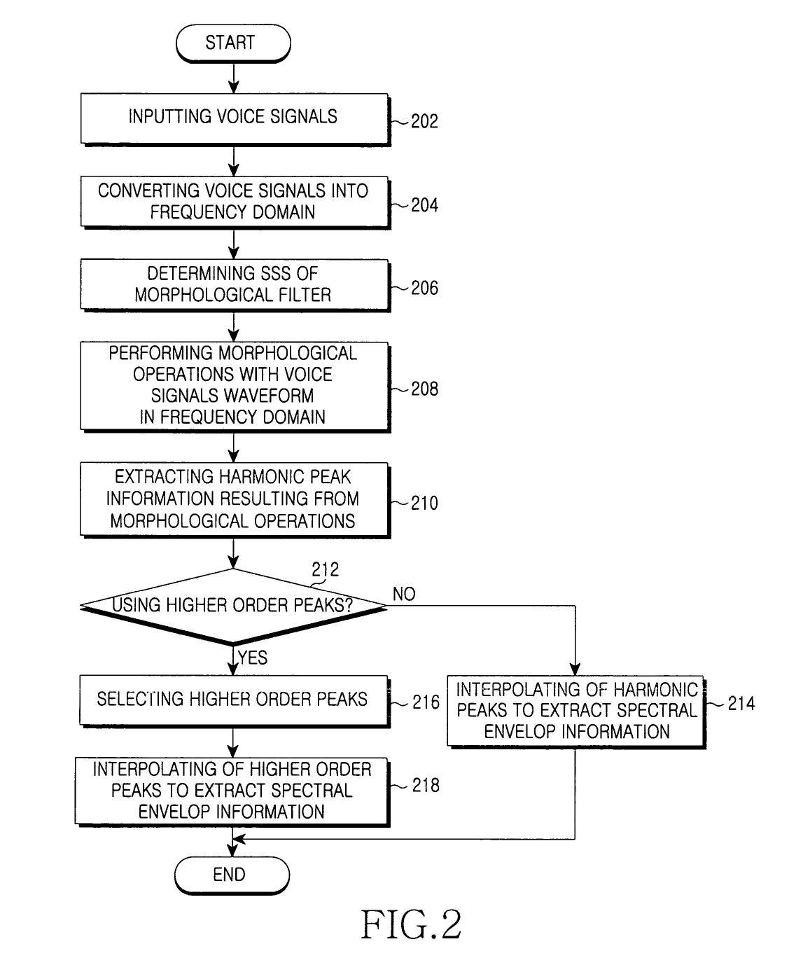

In FIG. 2, the spectral information prediction apparatus receives the voice signals through an input device such as a microphone in step 202, and it converts the voice signals from the time domain into the frequency domain by using a procedure such as FFT in step 204.

Thereafter, the spectral information prediction apparatus determines the SSS of the morphological filter 140 in step 206. In this case, the SSS is to set the size of the sliding window for morphological operations, which size affects the performance of the morphological filter. The apparatus may cooperate with a pitch detector to detect the pitch of the voice signals, which is a determination factor of the SSS.

Then, the spectral information prediction apparatus performs the morphological operations with the waveform of the voice signals in the frequency domain by using the sliding window according to the SSS in step 208. In this case, the morphological operations may be dilation, erosion, opening or closing.

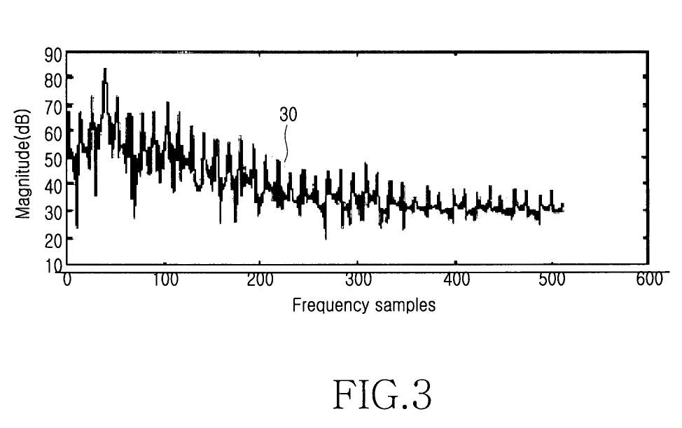

In reference to the dilation operation in FIG. 3, the spectral information prediction apparatus determines the maximum in each selected threshold set of the voice signals, i.e., in the sliding window, as the value of the threshold set. Thus, when performing the dilation operation with the voice signals waveform, the waveform image of discrete signals is obtained with each dilation region constantly having the maximum of the threshold set as represented by reference numeral 30.

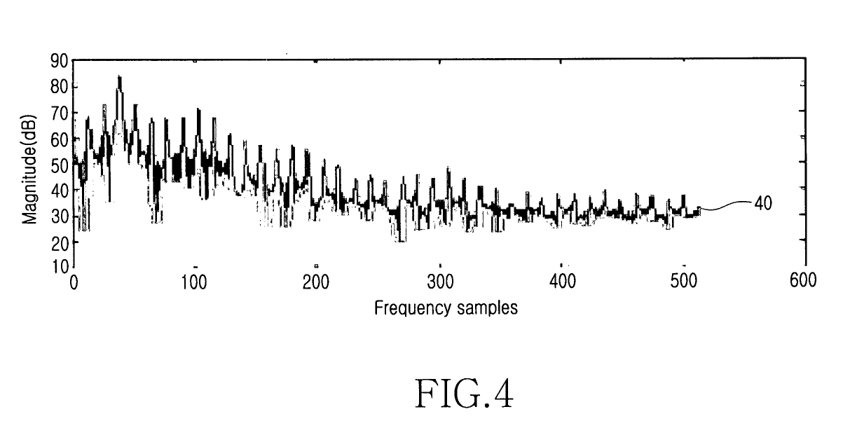

In reference to the erosion operation in FIG. 4, the spectral information prediction apparatus determines the minimum in each selected threshold set of the voice signals, i.e., in the sliding window, as the value of the threshold set. Thus, when performing the erosion operation with the voice signals waveform, the waveform image of discrete signals is obtained with each erosion region constantly having the minimum of the threshold set as represented by reference numeral 40.

Subsequently, the spectral information prediction apparatus extracts the harmonic peak information from the waveform image obtained by the morphological operations in step 210. To this end, it may employ one of the three procedures of heating peak extraction, midpoint extraction and tracking peak extraction. The heating peak extraction extracts the meeting point of each harmonic peak and a dilation or erosion region as the peak value. The midpoint extraction extracts the midpoint of each dilation or erosion region as the peak value. The tracking peak extraction extracts the substantial spectral peak causing each dilation or erosion region to be dilated or eroded.

Meanwhile, if the SSS is determined to be too small due to pitch error during determining the SSS of the morphological operation according to the pitch information, the spectral envelope information follows each harmonic, thereby causing spectral distortion. This problem may be prevented by eliminating incorrectly selected noise peaks before interpolation by selecting only higher order peaks.

The spectral information prediction apparatus determines in step 212 whether to use the harmonic peaks as previously extracted or to select the higher order peaks among them. If the higher order peaks are not required, the apparatus interpolates of the extracted harmonic peaks to extract the spectral envelope information in step 214.

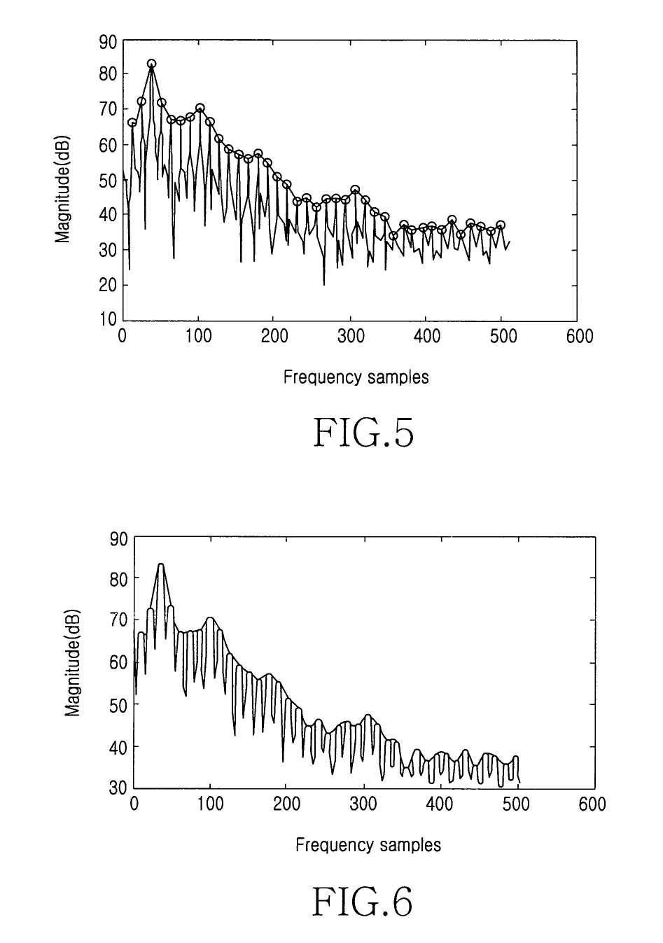

FIG. 5 illustrates the interpolation of the harmonic peaks obtained by the heating peak extraction according to the present invention. The small circles in the drawing represent the harmonic peaks extracted by heating peak extraction, which heating peaks are subjected to the interpolation by the spectral information prediction apparatus to predict the spectral envelope information of the voice signals.

In the mid-point extraction illustrated FIG. 6, the spectral information prediction apparatus interpolates of the mid-point of each dilation or erosion region to predict the spectral envelope information of the voice signals.

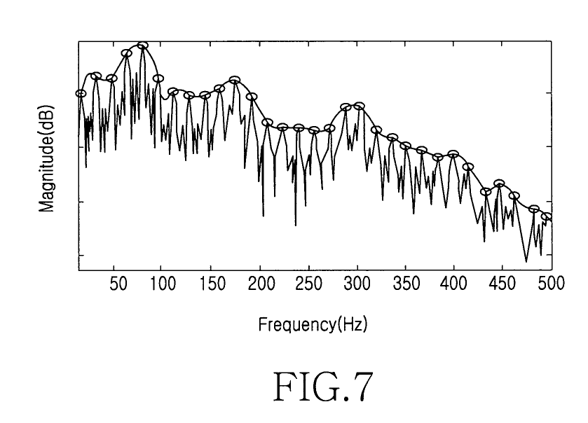

In the tracking peak extraction illustrated in FIG. 7, the small circles drawn in the drawing are the substantial spectral peaks extracted by the tracking peak extraction, which are subjected to the interpolation by the spectral information prediction apparatus to predict the spectral envelope information of the voice signals.

Meanwhile, if the higher order peaks are required, the spectral information prediction apparatus defines the order of each of the harmonic peaks extracted by the harmonic peak extractor 150 to select the higher order peaks with more voice signal information in step 216.

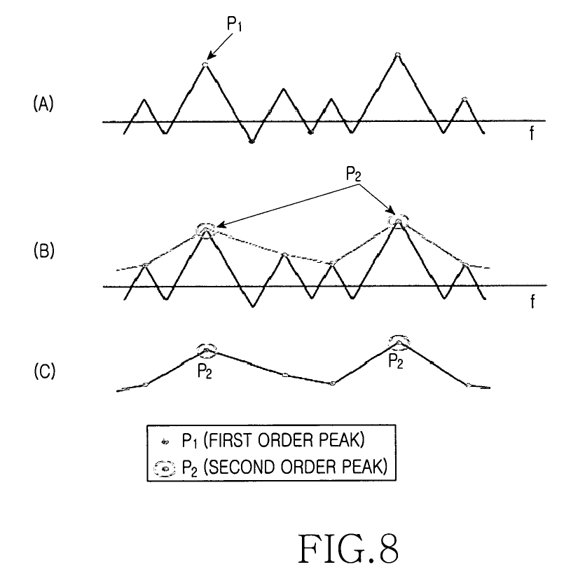

In the procedure of defining the higher order peaks illustrated in FIGS. 8A to 8C, the spectral information prediction apparatus defines the peaks extracted by the harmonic peak extractor 150 as the first order peaks P1, as shown in FIG. 8A. Then, it detects the peaks P2 appearing when the first order peaks P1 have been connected, as shown in FIG. 8B. The peaks P2 are defined as the second order peaks, as shown in FIG. 8C. In this case, while FIGS. 8A to 8C illustrate the defining procedure up to the second order peaks, the third order peaks may be defined from the second order peaks, and thus the same rule applies to an arbitrary Nth (N being a natural number) order peaks.

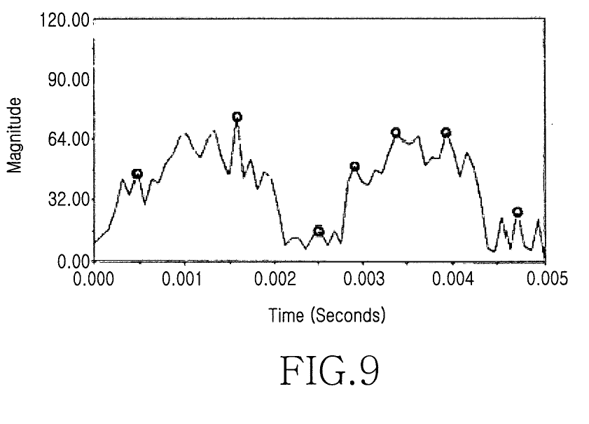

Subsequently, the spectral information prediction apparatus selects the higher order peaks with more voice signal information among the hierarchical order peaks. In this case, it is preferable to select the second or third order peaks because they usually have more voice or audio signal information. FIG. 9 illustrates 200Hz sinusoidal signals in the Gaussian noise in connection with the second order peaks selected, wherein the small circles represent the selected second order peaks.

After selecting the higher orders, the spectral information prediction apparatus interpolates of the higher order peaks to predict the spectral envelope information in step 218. For example, it connects the second order peaks selected to predict the spectral envelope information as shown in FIG. 9. Thus, when using the higher order peaks, the noise peaks are removed by selecting the higher order peaks (second order peaks or above) among the whole peaks, thereby preventing signal distortion.

As described above, the present invention provides a voice or audio processing system for predicting the spectral information of voice signals more accurately than the conventional technology by using their own harmonic peaks without making a presumption for them. In addition, the invention employs the morphological operations so as to quickly extract the harmonic peaks, which are only interpolated of to detect the spectral envelope, thus expediting the prediction of the spectral information with significantly reduced computation. Further, the invention selects the higher order peaks among the extracted harmonic peaks, preventing the spectral distortion resulting from the morphological operations based on the incorrectly selected SSS due to pitch information error. Moreover, the quick and correct extraction of the spectral envelope according to the invention enables the voice signal processing system to quickly and correctly encode, recognize, intensify and synthesize the voice signals. Particularly, the invention may be effectively and preferably used for mobile devices limited in computation and storage capacity, such as mobile terminal, a personal digital assistant (PDA) and an MPEG-1 Audio Layer 3 (MP3) player.

While the invention has been shown and described with reference to a certain preferred embodiment thereof, it will be understood by those skilled in the art that various changes in form and details may be made therein without departing from the spirit and scope of the invention.

What is claimed is:

1. An apparatus for predicting the spectral information of voice signals, comprising:
a voice signal input device for inputting the voice signals;
a morphological filter for performing morphological operations with the waveform image of said voice signals;
a harmonic peak extractor for extracting harmonic peaks as a result of the morphological operations; and
a spectral envelope prediction device for predicting spectral envelope information of said voice signals by interpolating said harmonic peaks.

2. The apparatus of claim 1, further including a frequency domain converter for converting the voice signals in a time domain into voice signals in a frequency domain.

3. The apparatus of claim 1, further including a structuring set size (SSS) determining device for determining the SSS of said morphological filter.

4. The apparatus of claim 1, wherein said morphological operations include at least one of dilation, erosion, opening and closing.

5. The apparatus of claim 4, wherein said dilation is to determine a maximum of each of selected threshold sets of the waveform image of said voice signals as a threshold set value.

6. The apparatus of claim 4, wherein said erosion is to determine a minimum of each of selected threshold sets of the waveform image of said voice signals as a threshold set value.

7. The apparatus of claim 1, wherein said harmonic peak extractor extracts the harmonic peaks by employing one of heating peak extraction, midpoint extraction and tracking peak extraction.

8. The apparatus of claim 7, wherein said heating peak extraction is a method for extracting a meeting point of each harmonic peak and a resultant value of performing morphological operations with each selected threshold set as the peak.

9. The apparatus of claim 7, wherein said midpoint extraction is a method for extracting a value obtained by performing morphological operations with a midpoint of each threshold set as the peak value.

10. The apparatus of claim 7, wherein said tracking peak extraction is a method for extracting a substantial spectral peak of each threshold set.

11. An apparatus for predicting spectral information of voice signals, comprising:
a voice signal input device for inputting voice signals;
a morphological filter for performing morphological operations with a waveform image of said voice signals;
a harmonic peak extractor for extracting harmonic peaks as a result of the morphological operations;
a high order peak selector for selecting higher order peaks among the extracted harmonic peaks; and
a spectral envelope prediction device for predicting spectral envelope information of said voice signals by interpolating said higher order peaks.

12. The apparatus of claim 11, wherein said high order peak selector defines the order of each of said harmonic peaks to select the higher order peaks with a larger amount of voice signal information.

13. The apparatus of claim 12, wherein said high order peak selector defines said harmonic peaks as first order peaks, and then in a series defines the peaks among the first order peaks as second order peaks, and continues to define the peaks in the series up to Nth (N represents a natural number) order peaks.

14. The apparatus of claim 12, wherein the higher order peaks with the larger amount of voice signal information are second or third order peaks.

15. The apparatus of claim 11, further including a frequency domain converter for converting the voice signals in a time domain into a voice signals in a frequency domain.

16. The apparatus of claim 11, further including a structuring set size (SSS) determining device for determining the SSS of said morphological filter.

17. The apparatus of claim 11, wherein said morphological operations include at least one of dilation, erosion, opening and closing.

18. The apparatus of claim 17, wherein said dilation is to determine a maximum of each of selected threshold sets of the waveform image of said voice signals as a threshold set value.

19. The apparatus of claim 17, wherein said erosion is to determine a minimum of each of selected threshold sets of the waveform image of said voice signals as a threshold set value.

20. The apparatus of claim 11, wherein said harmonic peak extractor extracts the harmonic peaks by employing one of heating peak extraction, midpoint extraction and tracking peak extraction.

21. The apparatus of claim 20, wherein said heating peak extraction is a method for extracting a meeting point of each harmonic peak and a resultant value of performing morphological operations with each selected threshold set as the peak.

22. The apparatus of claim 20, wherein said midpoint extraction is a method for extracting a value obtained by performing morphological operations with a midpoint of each threshold set as the peak value.

23. The apparatus of claim 20, wherein said tracking peak extraction is a method for extracting a substantial spectral peak of each threshold set.

24. A method for predicting spectral information of voice signals, comprising the steps of:
inputting the voice signals;
performing morphological operations with a waveform image of said voice signals;
extracting harmonic peaks as a result of the morphological operations; and
predicting spectral envelope information of said voice signals by interpolating said harmonic peaks.

25. The method of claim 24, further including converting the voice signals in a time domain into voice signals in a frequency domain.

26. The method of claim 24, further including determining a structuring set size (SSS) of a morphological filter for performing said morphological operations.

27. The method of claim 24, wherein the step of performing morphological operations includes performing at least one of dilation, erosion, opening and closing.

28. A method as defined in claim 27, wherein the step of performing said dilation is to determine a maximum of each of selected threshold sets of the waveform image of said voice signals as a threshold set value.

29. The method of claim 27, wherein the step of performing said erosion is to determine a minimum of each of selected threshold sets of the waveform image of said voice signals as a threshold set value.

30. The method of claim 24, wherein the step of extracting the harmonic peaks is to extract a meeting point of each harmonic peak and a resultant value of performing morphological operations with each selected threshold set as the peak.

31. The method of claim 24, wherein the step of extracting the harmonic peaks is to extract a value obtained by performing morphological operations with a midpoint of each threshold set as the peak value.

32. The method of claim 24, wherein the step of extracting the harmonic peaks is to extract a substantial spectral peak of each threshold set.

33. The method of claim 24, further including:
selecting higher order peaks among the extracted harmonic peaks; and
predicting the spectral envelope information of said voice signals by interpolating said higher order peaks.

34. The method of claim 33, wherein the step of selecting higher order peaks further includes:
defining an order of each of said harmonic peaks; and
selecting the higher order peaks with a larger amount of voice signal information.

35. The method of claim 34, wherein the step of defining the order of each of said harmonic peaks further includes:
defining said harmonic peaks as first order peaks;
defining, in a series, the peaks among the first order peaks as second order peaks; and continuing to define the peaks in the series up to Nth (N represents a natural number) order peaks.

36. The method of claim 34, wherein the higher order peaks with a larger amount of voice signal information are second or third order peaks.
